(19) United States
(12) Patent Application Publication
(10) Pub. No.: US 2023/0289582 A1
(43) Pub. Date: Sep. 14, 2023

(54) NEURON CIRCUIT WITH SYNAPTIC WEIGHT LEARNING

(71) Applicant: Electronics and Telecommunications Research Institute, Daejeon (KR)

(72) Inventors: Young Hwan BAE, Daejeon (KR); Jae-Jin LEE, Daejeon (KR); Tae Wook KANG, Daejeon (KR); Sung Eun KIM, Daejeon (KR); Kyung Jin BYUN, Daejeon (KR); Kwang IL OH, Daejeon (KR); In San JEON, Daejeon (KR)

(73) Assignee: Electronics and Telecommunications Research Institute, Daejeon (KR)

(21) Appl. No.: 18/084,234

(22) Filed: Dec. 19, 2022

(30) Foreign Application Priority Data
Mar. 14, 2022 (KR) 10-2022-0031414

(51) Int. Cl. G06N 3/063; G06N 3/049

(52) U.S. Cl. CPC G06N 3/063; G06N 3/049

(57) ABSTRACT

A neuron circuit including a first internal circuit that receives a plurality of spike input signals, generates a first sum value by summing a plurality of synaptic weights corresponding to the plurality of spike input signals, and outputs a second sum value by adding a membrane potential value to the first sum value, a spike generating circuit that generates a spike output signal, a membrane potential generating circuit that generates the membrane potential value, a second internal circuit that counts a last spike time based on the spike output signal, and an online learning circuit that receives a last input time from the first internal circuit and performs LTP learning based on the last input time or receives the last spike time from the second internal circuit and performs LTD learning based on the last spike time.

### CROSS-REFERENCE TO RELATED APPLICATIONS

This application claims priority under 35 U.S.C. § 119 to Korean Patent Application No. 10-2022-0031414 filed on Mar. 14, 2022, in the Korean Intellectual Property Office, the disclosures of which are incorporated by reference herein in their entireties.

### BACKGROUND

Embodiments of the present disclosure described herein relate to a neuron circuit for learning synaptic weights, and more particularly, relate to a neuron circuit capable of online learning in a spiking neural network-based neuromorphic system.

An artificial neural network refers to a computing device for implementing an artificial neuron or interconnection of models thereof. A convolutional neural network or a recursive neural network has been proposed as a method of implementing an artificial neural network. Furthermore, research on a spiking neural network (SNN) for constructing the artificial neural network by mimicking a human biological structure is emerging similarly to a human brain structure.

The SNN may learn a weight of a synapse (hereinafter, referred to as a “synaptic weight”) by using a spike timing dependent plasticity (STDP) algorithm. Batch learning performed in units of batch after data to be learned is bundled into specific units may be used for SNN learning. In general, the batch learning is performed offline because the batch learning consumes a lot of time and resources. However, the batch learning requires re-learning by using full data for further learning on new data. The result needs to be uploaded back to a final reasoning system. This method may require a lot of time and cost.

Meanwhile, online learning refers to learning a system by sequentially inputting data generated in a field one by one or inputting data in small groups. The online learning is fast and inexpensive at every learning step, and the system may learn data as soon as the data is generated. Because data that has been learned does not need to be stored, there is no need for large memory. Additional learning is possible by using additional data generated in the field with respect to the result learned from the server, thereby greatly improving the flexibility of the system.

To enable the online learning in the SNN, a hardware-implemented neuron circuit itself needs to have a learning function. Because neuron circuits as many as possible need to be implemented on a chip, the neuron circuit needs to perform quick learning with as little hardware as possible and have a structure with high learning accuracy.

### SUMMARY

Embodiments of the present disclosure provide a neuron circuit that learns synaptic weights through online learning in a spiking neural network-based neuromorphic system.

According to an embodiment, a neuron circuit includes a first internal circuit that receives a plurality of spike input signals, generates a first sum value by summing a plurality of synaptic weights corresponding to the plurality of spike input signals, and outputs a second sum value by adding a membrane potential value to the first sum value, a spike generating circuit that generates a spike output signal by comparing the second sum value with a threshold potential value, a membrane potential generating circuit that generates the membrane potential value, which is obtained by subtracting the threshold potential value from the second sum value, based on the spike output signal and a lateral suppression signal, a second internal circuit that counts a last spike time based on the spike output signal, and an online learning circuit that receives the last input time from the first internal circuit and performs long-term potentiation (LTP) learning based on the last input time or receives a last spike time from the second internal circuit and performs long-term depression (LTD) learning based on the last spike time.

According to an embodiment, the first internal circuit includes an input register that converts and stores the plurality of spike input signals into a Boolean value, a first count register that counts the last input time, which is a time difference between a time, at which each of the plurality of spike input signals is input, and a time at which the spike output signal is generated, a synaptic weight register that generates the first sum value by sequentially extracting and summing synaptic weight values, the Boolean value of each of which is “True”, and a first adder that generates the second sum value by adding the membrane potential to the first sum value.

According to an embodiment, the first count register further resets the last input time when the spike output signal is 1.

According to an embodiment, the spike generating circuit includes a comparator that compares the second sum value with the threshold potential value, and generates a spike generation signal when the second sum value is greater than the threshold potential value, a spike generator that generates the spike output signal in response to the spike generation signal, and a Vth regulator that provides the comparator with the threshold potential value by adjusting the threshold potential value based on the spike output signal.

According to an embodiment, the Vth regulator is further configured to output the threshold potential value by adding a threshold potential regulation value to an existing threshold potential value thus stored, when the spike output signal is ‘1’.

According to an embodiment, the membrane potential generating circuit includes a first MUX that outputs a leakage value or the threshold potential value based on the spike output signal, a first subtractor that subtracts an output value of the first MUX from the second sum value, a second MUX that outputs an output value of the first subtractor or ‘0’ based on a selection signal, and a membrane potential register that stores an output value of the second MUX as the membrane potential value.

According to an embodiment, the first MUX is further configured to output the threshold potential value when the spike output signal is ‘1’, and outputs the leakage value, which is a constant value obtained by modeling a leakage current with time, when the spike output signal is ‘0’.

According to an embodiment, the second MUX is further configured to output ‘0’ based on the selection signal of ‘1’ when each of an inverted signal of the spike output signal and the lateral suppression signal is ‘1’, and outputs an output value of the first subtractor based on the selection signal of ‘0’ when at least one of the inverted signal and the lateral suppression signal is not ‘1’.

According to an embodiment, the second internal circuit includes a second count register that counts the last spike time, which is a time elapsed after a spike has finally generated.

According to an embodiment, the second count register is further configured to reset the last spike time when the spike output signal is ‘1’.

According to an embodiment, the online learning circuit includes an LTP learning circuit that updates the plurality of synaptic weights based on the last input time and an LTD learning circuit that updates the plurality of synaptic weights based on the last spike time.

According to an embodiment, the LTP learning circuit includes a last input time register that loads and stores the last input time from the first internal circuit, an LTD table that stores a second weight learning rate value, which is quantized by setting the last spike time to an index, a first weight register that loads a current synaptic weight from the first internal circuit and uploads a first update synaptic weight to the first internal circuit, and a second adder that generates the first update synaptic weight by adding the first weight learning rate value to the current synaptic weight.

According to an embodiment, the LTD learning circuit includes a last spike time register that loads and stores the last spike time from the second internal circuit, an LTD table that stores a second weight learning rate value, which is quantized by setting the last spike time to an index, a second weight register that loads the current synaptic weight from the first internal circuit and uploads a second update synaptic weight to the first internal circuit, and a second subtractor that generates the second update synaptic weight by subtracting the second weight learning rate value from the current synaptic weight.

According to an embodiment, the second weight register is further configured to load the current synaptic weight or to upload the second update synaptic weight, in response to an activation signal.

According to an embodiment, the first weight register and the second weight register consist of a single integrated weight register.

According to an embodiment, the online learning circuit further includes a MUX circuit that outputs the first update synaptic weight to the integrated weight register when the spike output signal is ‘1’ and outputs the second update synaptic weight to the integrated weight register when the spike output signal is ‘0’.

According to an embodiment, a spiking neural network circuit includes one or more hidden layers. The one or more hidden layers include a plurality of neuron circuits, each of which performs online learning based on a spike timing dependent plasticity (STDP) algorithm, and an OR gate that performs an OR operation on a first spike output signal, which is an output of a first neuron circuit, and a second spike output signal, which is an output of a second neuron circuit, with respect to the first neuron circuit and the second neuron circuit, which are adjacent to each other, among the plurality of neuron circuits.

According to an embodiment, the OR gate is configured to generate a lateral suppression signal based on the first spike output signal and the second spike output signal.

According to an embodiment, each of the plurality of neuron circuits includes a first internal circuit that receives a plurality of spike input signals, generates a first sum value by summing a plurality of synaptic weights corresponding to the plurality of spike input signals, and outputs a second sum value by adding a membrane potential value to the first sum value, a spike generating circuit that generates a spike output signal by comparing the second sum value with a threshold potential value, a membrane potential generating circuit that generates the membrane potential value, which is obtained by subtracting the threshold potential value from the second sum value, based on the spike output signal and a lateral suppression signal, a second internal circuit that counts a last spike time based on the spike output signal, and an online learning circuit that receives the last input time from the first internal circuit and performs long-term potentiation (LTP) learning based on the last input time or receives a last spike time from the second internal circuit and performs long-term depression (LTD) learning based on the last spike time.

### BRIEF DESCRIPTION OF THE FIGURES

The above and other objects and features of the present disclosure will become apparent by describing in detail embodiments thereof with reference to the accompanying drawings.

FIG. 1 is a diagram for describing an operation of a spiking neural network, according to an embodiment of the present disclosure.

FIGS. 2A and 2B are diagrams conceptually illustrating a relationship between a neuron and a synapse of a spiking neural network, according to an embodiment of the present disclosure.

FIG. 3 is a block diagram of a neuron circuit, according to an embodiment of the present disclosure.

FIG. 4 is a block diagram illustrating a specific embodiment of the neuron circuit of FIG. 3.

FIG. 5 is a diagram illustrating a membrane potential after spike generation of the neuron circuit of FIG. 4.

FIGS. 6A and 6B are diagrams illustrating the LTP learning circuit of FIG. 4.

FIGS. 7A and 7B are diagrams illustrating the LTD learning circuit of FIG. 4.

FIGS. 8 and 9 are diagrams illustrating that an LTP learning circuit and an LTD learning circuit are integrated.

FIG. 10 is a diagram illustrating a hidden layer, to which a neuron circuit is applied, according to an embodiment of the present disclosure.

### DETAILED DESCRIPTION

Hereinafter, embodiments of the present disclosure will be described in detail and clearly to such an extent that an ordinary one in the art easily implements the present disclosure. However, because the present disclosure may be embodied in various different forms within the scope of claims, embodiments described herein are merely examples, regardless of whether they are expressed or not. In other words, the present disclosure is not limited to embodiments disclosed herein and may be implemented in various different forms.

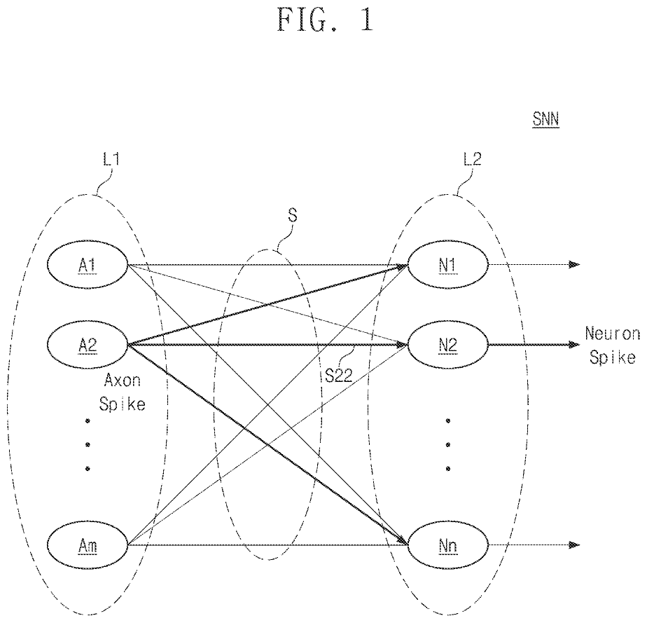

FIG. 1 is a diagram for describing an operation of a spiking neural network, according to an embodiment of the present disclosure. Referring to FIG. 1, an SNN may include a first layer L1, a second layer L2, and synapses ‘S’. The first layer L1 may include ‘m’ axons A1 to Am. The second layer L2 may include ‘n’ neurons N1 to Nn. The synapses ‘S’ may connect the axons A1 to Am and the neurons N1 to Nn. Here, “m” and “n” may be any natural number, and “m” and “n” may be different numbers or the same number.

Each of the axons A1 to Am included in the first layer L1 may output axon spikes. The synapses ‘S’ may deliver a spike signal having a weighted synaptic weight to the neurons N1 to Nn included in the second layer L2 based on the axon spikes thus output. Even though an axon spike is output from one axon, each of the spike signals delivered from the synapses ‘S’ to the neurons N1 to Nn may vary with a synaptic weight that is the connection strength of each of the synapses ‘S’. For example, when a synaptic weight of a first synapse is greater than a synaptic weight of a second synapse, a neuron connected with the first synapse may receive a spike signal of a greater value than a neuron connected with the second synapse.

Each of the neurons N1 to Nn included in the second layer L2 may receive the spike signal delivered from the synapses ‘S’. Each of the neurons N1 to Nn that has received the spike signal may output a neuron spike based on the received spike signal. For example, when the accumulated value of the spike signal received by the second neuron N2 becomes greater than a threshold, the second neuron N2 may output a neuron spike.

For example, as illustrated in FIG. 1, when the second axon A2 outputs an axon spike, the synapses “S” connected with the second axon A2 may deliver spike signals to the neurons N1 to Nn. The delivered spike signals may vary with synaptic weights of the synapses “S” connected with the second axon A2. A spike signal may be delivered to the second neuron N2 from a synapse S22 connecting the second axon A2 and the second neuron N2. When a value of the accumulated spike signal of the second neuron N2 becomes greater than the threshold depending on the delivered spike signal, the second neuron N2 may output a neuron spike.

As illustrated in FIG. 1, a layer where the axons A1 to Am are included may be a layer prior to a layer where the neurons N1 to Nn are included. Also, the layer where the neurons N1 to Nn are included may be a layer following the layer where the axons A1 to Am are included. Accordingly, the spike signals may be delivered to the neurons N1 to Nn in the next layer depending on synaptic weights weighted in axon spikes output from the axons A1 to Am, and the neurons N1 to Nn may output neuron spikes based on the delivered spike signals.

Although not shown in FIG. 1, spike signals may be delivered to neurons of the next layer depending on outputs of the neuron spikes in the second layer L2. For example, when spike signals are delivered from the second layer L2 to a third layer, axons of the second layer L2 may output the axon spikes depending on the outputs of the neuron spikes. The spike signals, to which synaptic weights are weighted, may be delivered to neurons of the third layer based on the output axon spikes. When an accumulation value of the delivered spike signal is greater than a threshold, neurons of the third layer may output neuron spikes. That is, one layer may include both axons and neurons, or either axons or neurons.

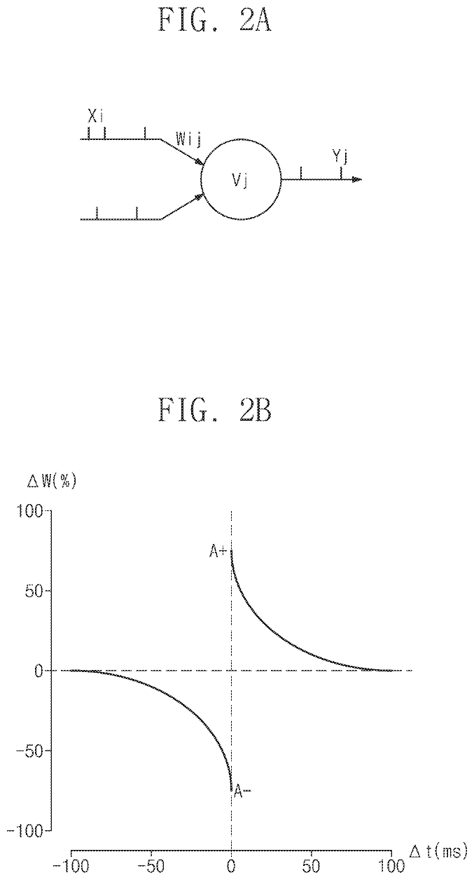

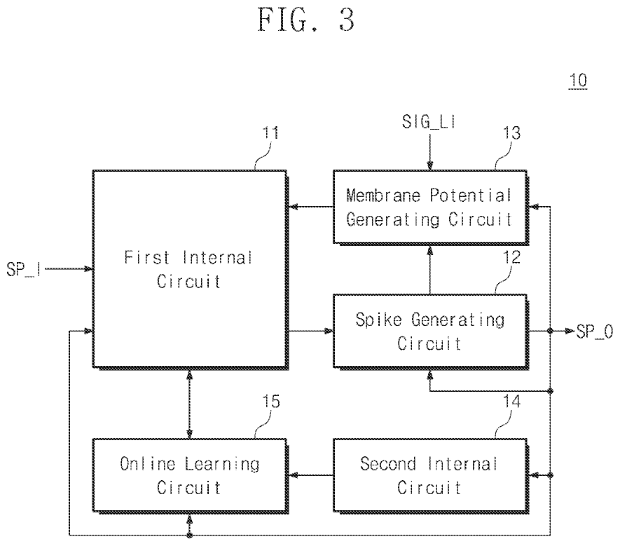

FIGS. 2A and 2B are diagrams conceptually illustrating a relationship between a neuron and a synapse of a spiking neural network, according to an embodiment of the present disclosure.

Referring to FIG. 2A, a neuron Vj receives a spike Xi fired from previous neurons through a synapse, and receives the spike Xi of which the size is adjusted by a synaptic weight Wij. The neuron Vj accumulates the product of the input spike and the synaptic weight to the membrane potential, and when the membrane potential is greater than a threshold voltage Vth, the neuron Vj fires and outputs a spike Yj.

The spike Yj fired from the neuron Vj is delivered to the next neuron through a synapse. In this way, the amount of signal for delivering a spike of the previous neuron PRE-neuron to the next neuron POST-neuron is determined by the synaptic weight, and thus the SNN learns the synaptic weight in a learning stage.

In the meantime, because the SNN is incapable of differentiating a membrane potential of the neuron and the synaptic weight, the SNN may not be learned by a gradient descent method or an error backpropagation method, which are commonly used in conventional deep learning. Accordingly, the SNN is learned in an STDP method, which is a mechanism for changing the connection strength of a synapse in a biological synapse.

The biological synapse serves as short-term and long-term memory by using the chemistry of neurotransmitters. The short-term memory is implemented by neurotransmitters that remain after a spike is delivered. The long-term memory is implemented by the connection strength of a synapse that varies depending on a change in the number of receptors or a synapse structure. A process of creating a long-term memory of synapses in the STDP method, which is a synapse connection strength change mechanism, is referred to as “learning”.

Referring to an STDP function of FIG. 2B, Δt is a difference between a spike occurrence time of a neuron after a synapse and a spike time of a neuron before the synapse (Δt=tₚₒₛₜ−tₚᵣₑ).

ΔW=A*exp(−Δt) (if Δt>0 then A=A+,else A=A−) [Equation 1]

Referring to Equation 1, as a time difference between spikes before and after a synapse is small, a change ΔW in connection strength increases exponentially. When there is causality (Δt>0), the change ΔW in connection strength has a positive value of ΔW. Otherwise (Δt<0), the change ΔW in connection strength has a negative value of ΔW. In Equation 1, a value of A+ and a value of A− are constant values for adjusting a learning rate.

An increase in a synapse weight as Δt is positive and the time difference is small is referred to as “long-term potentiation (LTP)”. A decrease in a synapse weight as Δt is negative and the time difference is small is referred to as “long-term depression (LTD)”. In other words, when there is causality in which the spike firing of a neuron before a synapse causes a neuron after the synapse to fire repeatedly or continuously (Δt>0), the connection strength of the synapse between the neuron before the synapse and the neuron after the synapse is potentiated in a long term. Otherwise (Δt<0), the connection strength of the synapse between the neuron before the synapse and the neuron after the synapse is depressed in a long term. In this way, the SNN may be learned by using the STDP method of adjusting a synaptic weight between neurons based on relative spike timing.

FIG. 3 is a block diagram of a neuron circuit, according to an embodiment of the present disclosure. Referring to FIG. 3, a neuron circuit 10 may include a first internal circuit 11, a spike generating circuit 12, a membrane potential generating circuit 13, a second internal circuit 14, and an online learning circuit 15.

The neuron circuit 10 may receive a spike input signal SP_I from neurons before a synapse. The neuron circuit 10 may generate a spike output signal SP_O by calculating the spike input signal SP_I based on synaptic weights learned through online learning. The neuron circuit 10 may provide the spike output signal SP_O to neurons of the next layer.

The first internal circuit 11 may store the spike input signal SP_I and synaptic weights. Moreover, the first internal circuit 11 may count and store a last input time required for LTP learning. To this end, the first internal circuit 11 may include one or more registers. According to an embodiment, the last input time may be obtained by counting whether the spike output signal SP_O is generated after a predetermined time expires after the spike input signal SP_I is input. When the spike output signal SP_O is 1, the last input time may be reset.

The first internal circuit 11 may sum the synaptic weights depending on the spike input signal SP_I and may further sum a membrane potential value received from the membrane potential generating circuit 13. The first internal circuit 11 may provide the spike generating circuit 12 with a final summed value.

The spike generating circuit 12 may generate the spike output signal SP_O by comparing a value received from the first internal circuit 11 with a threshold potential value. The spike output signal SP_O may be 1 or 0. The threshold potential value may be adjusted depending on the spike output signal SP_O. The spike generating circuit 12 may provide the adjusted threshold potential value to the membrane potential generating circuit 13.

The membrane potential generating circuit 13 may receive the final summed value and the adjusted threshold potential value from the spike generating circuit 12. The membrane potential generating circuit 13 may perform a subtraction operation depending on the spike output signal SP_O. The membrane potential generating circuit 13 may generate a membrane potential value as a result of performing a subtraction operation. The generated membrane potential value may be provided to the first internal circuit 11.

The second internal circuit 14 may count and store a last spike time in response to the spike output signal SP_O. The last spike time may be an integer indicating how much time has elapsed since the last spike was created. The second internal circuit 14 may provide the last spike time to the online learning circuit 15.

The online learning circuit 15 may perform LTP learning or LTD learning. The online learning circuit 15 may perform LTP learning by updating synaptic weights based on the last input time. According to an embodiment, the online learning circuit 15 may perform LTD learning by updating synaptic weights based on the last spike time. In this case, an activation signal may be generated based on the spike output signal SP_O.

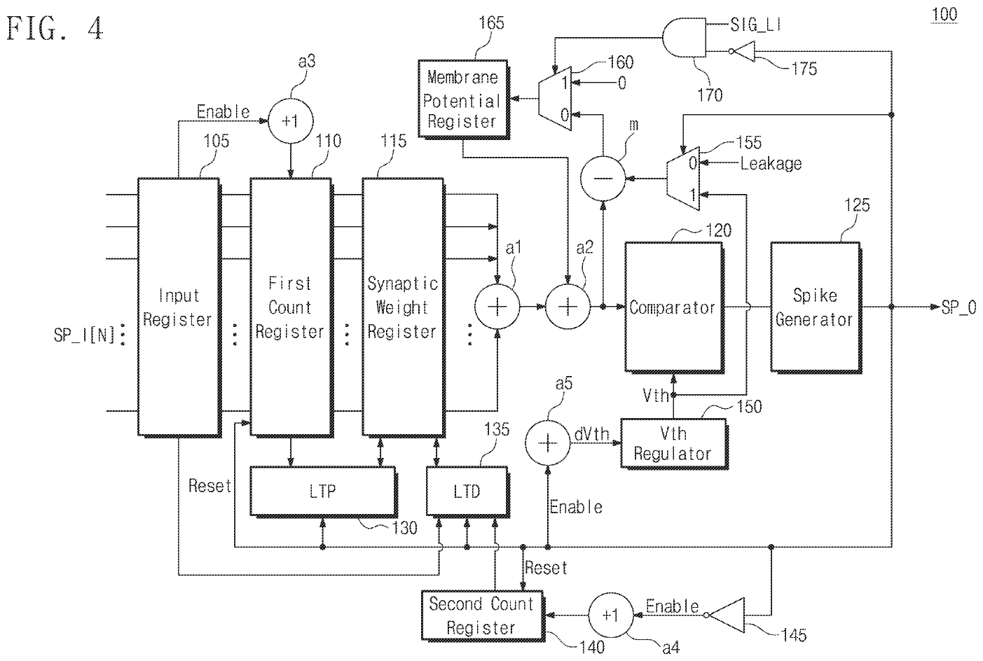

FIG. 4 is a block diagram illustrating a specific embodiment of the neuron circuit of FIG. 3. Referring to FIGS. 3 and 4, a neuron circuit 100 may include an input register 105, a first count register 110, a synaptic weight register 115, a comparator 120, a spike generator 125, an LTP learning circuit (LTP) 130, an LTD learning circuit (LTD) 135, a second count register 140, a first inverter 145, a Vth regulator 150, a first MUX 155, a second MUX 160, a membrane potential register 165, an AND gate 170, a second inverter 175, first to fifth adders a1, a2, a3, a4, and a5, and a subtractor ‘m’.

For example, the first internal circuit 11 may include the input register 105, the first count register 110, the synaptic weight register 115, and the first to third adders a1, a2, and a3. For example, the spike generating circuit 12 may include the comparator 120, the spike generator 125, the Vth regulator 150, and the fifth adder a5. For example, the membrane potential generating circuit 13 may include the first MUX 155, the second MUX 160, the membrane potential register 165, the AND gate 170, the second inverter 175, and the subtractor ‘m’. For example, the second internal circuit 14 may include the second count register 140, the first inverter 145, and the fourth adder a4. For example, the online learning circuit 15 may include the LTP 130 and the LTD 135.

For convenience of description, configurations of the first internal circuit 11, the spike generating circuit 12, the membrane potential generating circuit 13, the second internal circuit 14, and the online learning circuit 15 are limited. However, each configuration is not limited thereto and may be changed arbitrarily.

The input register 105 may receive ‘N’ spike input signals SP_I[N] from neurons before a synapse and may store the spike input signals SP_I[N]. Because the spike input signals SP_I[N] are signals, each of which has a value of 1 or 0, the spike input signals SP_I[N] may be converted into a Boolean value of “True” or “False” based on whether a signal is present and then may be stored in the input register 105.

The first count register 110 may count whether the spike output signal SP_O is generated, after a predetermined time expires after each of the spike input signals SP_I[N] is input. That is, the first count register 110 may count the last input time. For example, whenever a series of the spike input signals SP_I[N] is input, the first count register 110 may store a register value (e.g., the last input time) of an index corresponding to each signal by increasing the register value by ‘1’ through the third adder a3.

In this case, the third adder a3 may operate based on an activation signal “enable” from the input register 105. Furthermore, the first count register 110 may receive the spike output signal SP_O and may be reset such that ‘N’ integer values (e.g., the last input time) stored in the first count register 110 are reset to zero.

The synaptic weight register 115 may store ‘N’ synaptic weight values. The synaptic weight register 115 may sequentially extract weight values of the index of which a value stored in the input register 105 is “True”, and may sum the extracted weight values by using the first adder a1. The value (hereinafter, referred to as a “first sum value”) summed through the first adder a1 may be added to a membrane potential value through the second adder a2. The membrane potential value may be a membrane potential value that remains after the previous spike is generated.

The comparator 120 may receive the summed value (hereinafter, referred to as a “second sum value”) through the second adder a2. The comparator 120 may compare the second sum value with a threshold potential value Vth. When the second sum value is greater than the threshold potential value Vth, the comparator 120 may generate a spike generation signal, and the spike generator 125 may generate the spike output signal SP_O in response to the spike generation signal. For example, in this case, the spike output signal SP_O may be 1. The spike output signal SP_O may be delivered to neurons of the next layer through a neural network.

According to an embodiment, when the spike output signal SP_O is 1, the activation signal “enable” may be applied to the fifth adder a5. The fifth adder a5 may provide a threshold potential regulation value dVth to the Vth regulator 150 in response to the activation signal “enable”. The Vth regulator 150 may add the threshold potential regulation value dVth to the threshold potential value Vth thus previously stored.

According to an embodiment, operations of the fifth adder a5 and the Vth regulator 150 may be referred to as a “threshold potential value regulating operation (Vth regulation)”. The threshold potential value regulating operation may provide an opportunity to generate a spike to various neurons by suppressing the continuous generation of a neuron that has generated a spike once in a learning stage. Accordingly, an opportunity for all neurons to learn equally may be provided, and learning accuracy may be improved.

The first MUX 155 may output a leakage value “Leakage” or the threshold potential value Vth in response to the spike output signal SP_O. The threshold potential value Vth may be a value adjusted by the Vth regulator 150. According to an embodiment, when the spike output signal SP_O is 1, a selection signal of the first MUX 155 may be 1. Otherwise, the selection signal of the first MUX 155 may be 0.

When the selection signal of the first MUX 155 is 0, the first MUX 155 may output the leakage value “Leakage”. The leakage value “Leakage” is a constant value of 0 or higher, and may be a value from modeling a leakage current with time. In this case, the subtractor ‘m’ may receive the leakage value “Leakage” from the first MUX 155 and may subtract the leakage value “Leakage” from the second sum value received from the second adder a2. The subtractor ‘m’ may provide the subtracted value to the second MUX 160.

When the selection signal of the first MUX 155 is 1, the first MUX 155 may output the threshold potential value Vth. In this case, the subtractor ‘m’ may receive the threshold potential value Vth from the first MUX 155 and may subtract the threshold potential value Vth from the second sum value received from the second adder a2. The subtractor ‘m’ may provide the subtracted value to the second MUX 160.

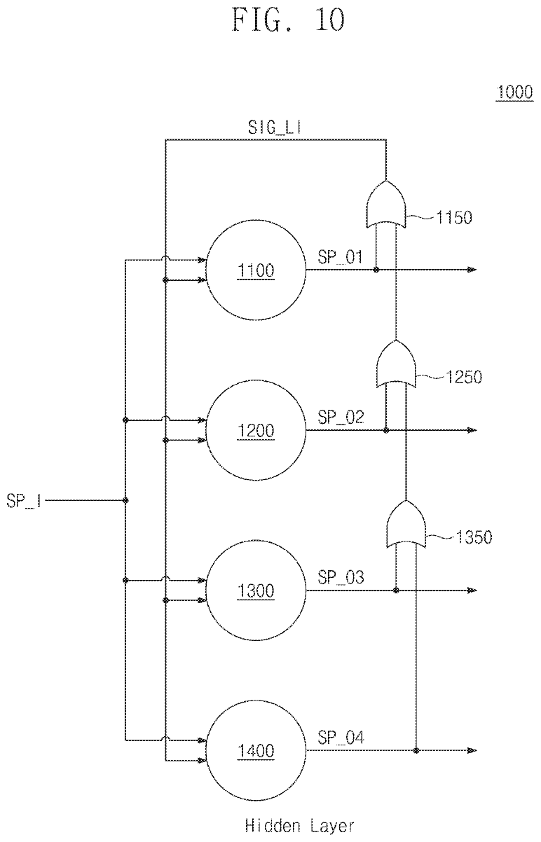

The second MUX 160 may output 0 or the subtracted value in response to an output of the AND gate 170. The AND gate 170 may receive a lateral suppression signal SIG_LI and an inverted signal of the spike output signal SP_O. When each of the lateral suppression signal SIG_LI and the inverted signal of the spike output signal SP_O is 1 (i.e., when the lateral suppression signal SIG_LI is 1 and the spike output signal SP_O is 0), the AND gate 170 may output an output signal of 1. In other cases, the AND gate 170 may output the output signal of 0. A detailed description of the lateral suppression signal SIG_LI will be described later with reference to FIG. 10.

The second inverter 175 may receive the spike output signal SP_O and may generate the inverted signal of the spike output signal SP_O. The second inverter 175 may provide the inverted signal of the spike output signal SP_O to the AND gate 170. When the spike output signal SP_O connected through the second inverter 175 is 0 (i.e., when a current neuron does not generate a spike, but another neuron in a layer generates a spike), the AND gate 170 may output an output signal of 1. The second MUX 160 may reset the membrane potential register 165 to 0 in response to the output signal of 1 and may suppress the spike generation of the neuron circuit 100. The second MUX 160 may provide the subtracted value to the membrane potential register 165 in response to the output signal of 0. The membrane potential register 165 may store the subtracted value. The membrane potential register 165 may provide the subtracted value as a membrane potential value to the second adder a2.

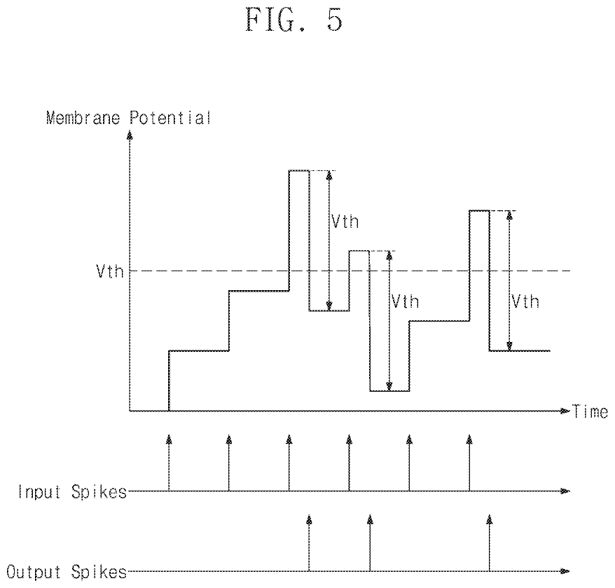

A conventional neuron circuit generates a spike and then resets a membrane potential value to 0, which is the lowest level. However, according to an embodiment of the present disclosure, the neuron circuit 100 may generate a spike and then may update the membrane potential value to a value obtained by subtracting only the threshold potential value Vth from the membrane potential value as illustrated in FIG. 5. Referring to FIG. 5, after a spike is generated, a membrane potential value “Membrane Potential” is updated to a value obtained by subtracting the threshold potential value Vth from the membrane potential value, three spike outputs “output spikes” may be generated for six periodic spike inputs “input spikes”. That is, according to an embodiment of the present disclosure, the neuron circuit 100 may generate a larger number of spike outputs for the same input, and thus a lot of input spikes may be provided to the next layer, thereby improving overall learning and inference accuracy.

Returning to FIG. 4, the first inverter 145 may generate an inverted signal of the spike output signal SP_O. According to an embodiment, when the spike output signal SP_O is 0, the first inverter 145 provides the inverted signal of the spike output signal SP_O to the fourth adder a4. This may operate as the activation signal “enable” of the fourth adder a4. The fourth adder a4 may increase a register value (e.g., a last spike time) of the second count register 140 by ‘1’ in response to the activation signal “enable”.

The second count register 140 may count how much time has elapsed since the last spike was created. That is, the second count register 140 may count the last spike time. The last spike time may be reset based on the spike output signal SP_O of 1. The second count register 140 may provide the stored last spike time to the LTD 135.

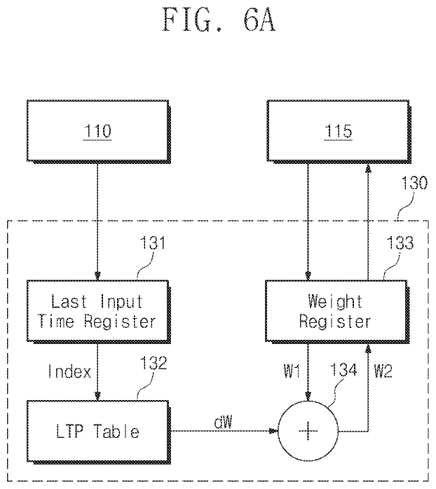

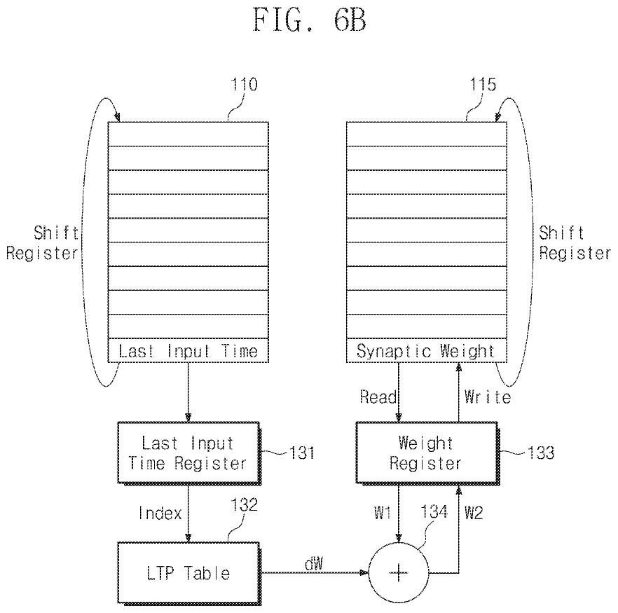

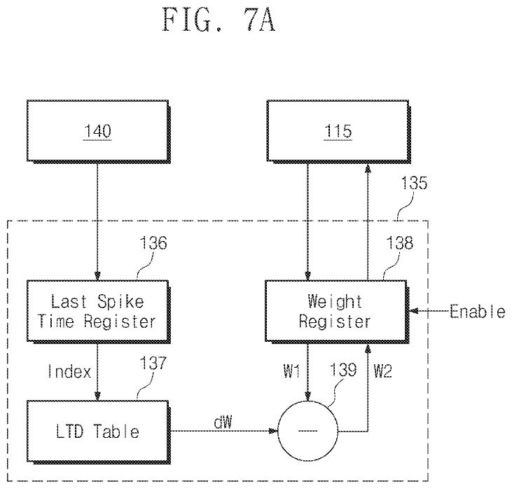

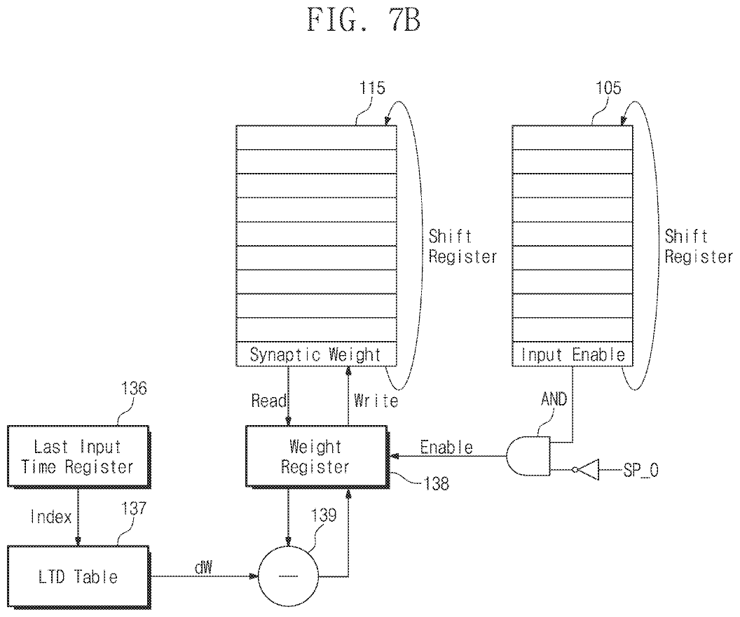

The LTP 130 and the LTD 135 may be in charge of online learning. The LTP 130 and the LTD 135 may not operate in a reasoning mode. The LTP 130 may perform LTP learning of a synapse, which will be described in detail with reference to FIGS. 6A and 6B. The LTD 135 may perform LTD learning of a synapse, which will be described in detail with reference to FIGS. 7A and 7B.

FIGS. 6A and 6B are diagrams illustrating the LTP learning circuit of FIG. 4. FIG. 6A is a block diagram of the LTP 130. FIG. 6B is a diagram illustrating a structure in which the LTP 130 of FIG. 6A is coupled to the neuron circuit 100.

Referring to FIGS. 4 and 6A, the LTP 130 may include a last input time register 131, an LTP table 132, a weight register 133, and an adder 134. The last input time register 131 may sequentially load register values stored from the first count register 110 ‘N’ times. The register values stored from the first count register 110 may be integer values, and may be the last input time corresponding to each of the spike input signals SP_I[N].

The last input time may be applied to an index of the LTP table 132. The LTP table 132 may output a weight learning rate value dW corresponding to the last input time. The result values obtained by substituting an integer value from 0 to M−1 with Δt and substituting ‘A’ with “A+” in Equation 1 (an equation of calculating an STDP learning rate) of FIG. 2B are quantized and stored in the LTP table 132. Through the LTP table 132, it is possible to reduce hardware and calculation delay time required when exponential function hardware for calculating Equation 1 is implemented in each neuron. A value of ‘M’ may be determined by a trade-off between a memory size and learning accuracy.

The weight register 133 may sequentially load register values stored from the synaptic weight register 115 ‘N’ times. The register values stored from the synaptic weight register 115 may be synaptic weights W1 before update. The weight register 133 may provide the current synaptic weight W1 to the adder 134. The adder 134 may add the weight learning rate value dW to the current synaptic weight W1. The adder 134 may provide an updated synaptic weight W2 to the weight register 133. The weight register 133 may upload the synaptic weight W2 to the synaptic weight register 115.

Referring to FIGS. 4, 6A, and 6B, each of the first count register 110 and the synaptic weight register 115 may be implemented as a shift register. A value at the lowest stage of the first count register 110 may be the last input time. The last input time register 131 may read out the last input time from the first count register 110. A value at the lowest stage of the synaptic weight register 115 may be a synaptic weight. The weight register 133 may read out the current synaptic weight W1 from the synaptic weight register 115 or may upload the updated synaptic weight W2. The first count register 110 and the synaptic weight register 115 may update all synaptic weight values through read and write operations while being sequentially rotated one by one.

FIGS. 7A and 7B are diagrams illustrating the LTD learning circuit of FIG. 4. FIG. 7A is a diagram illustrating a block diagram of the LTD 135. FIG. 7B is a diagram illustrating a structure in which the LTD 135 of FIG. 7A is coupled to the neuron circuit 100.

Referring to FIG. 7A, the LTD 135 may include a last spike time register 136, an LTD table 137, a weight register 138, and a subtractor 139. The last spike time register 136 may load a last spike time from the second count register 140.

The last spike time may be applied to an index of the LTD table 137, and the LTD table 137 may output the weight learning rate value dW corresponding to the last spike time. The result values obtained by substituting an integer value from 0 to M−1 with Δt and substituting ‘A’ with “A−” in Equation 1 (an equation of calculating an STDP learning rate) of FIG. 2B are quantized and stored in the LTD table 137.

The weight register 138 may sequentially load register values stored from the synaptic weight register 115 ‘N’ times. The weight register 138 is similar to the weight register 133 of FIG. 7A, and thus a detailed description thereof will be omitted to avoid redundancy. The weight register 138 may provide the current synaptic weight W1 to the subtractor 139. The subtractor 139 may subtract the weight learning rate value dW from the current synaptic weight W1. The subtractor 139 may provide the updated synaptic weight W2 to the weight register 138. According to an embodiment, the weight register 138 may operate only when the activation signal “enable” is applied.

Referring to FIGS. 4, 7A, and 7B, the synaptic weight register 115 may be implemented as a shift register. A value at the lowest stage of the synaptic weight register 115 may be a synaptic weight. The weight register 138 may read out the current synaptic weight W1 from the synaptic weight register 115 or may upload the updated synaptic weight W2.

According to an embodiment, the weight register 138 may operate in response to the activation signal “enable”. The activation signal “enable” may be generated based on an input activation signal “Input Enable” of the input register 105 and an inverted signal of the spike output signal SP_O. An AND gate AND may receive the input activation signal “Input Enable” and the inverted signal of the spike output signal SP_O. When each of the input activation signal “Input Enable” and the inverted signal of the spike output signal SP_O is 1, the AND gate AND may output the activation signal “enable” to the weight register 138. That is, the weight register 138 is currently receiving a spike input signal. However, only when a spike output signal is not generated, the activation signal “enable” may be 1, and thus the update may be made.

According to an embodiment, the input register 105 may be implemented as a shift register. The input register 105 and the synaptic weight register 115 may update all synaptic weight values through read and write operations while being sequentially rotated one by one.

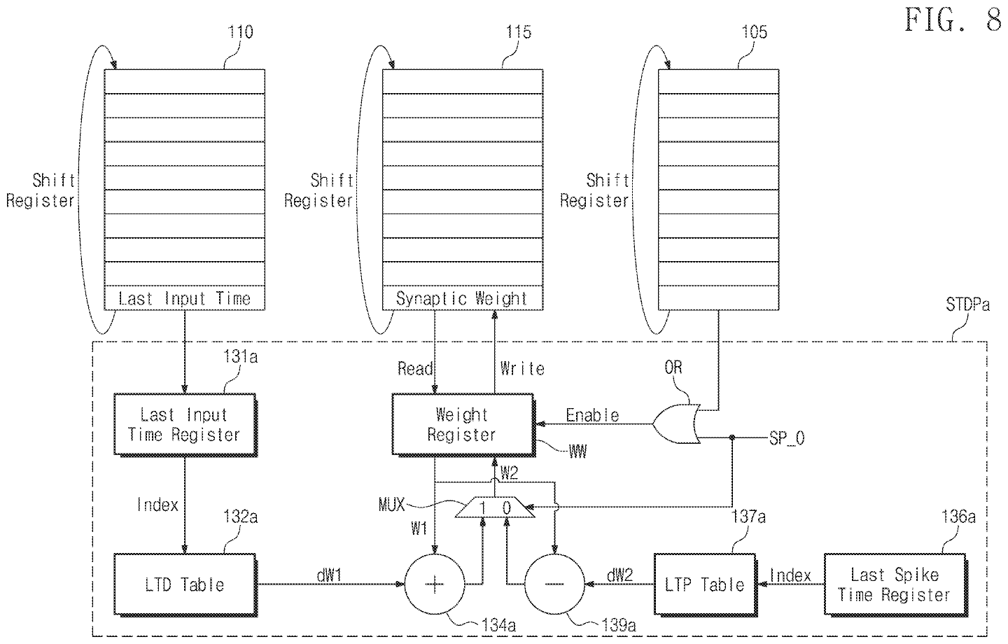

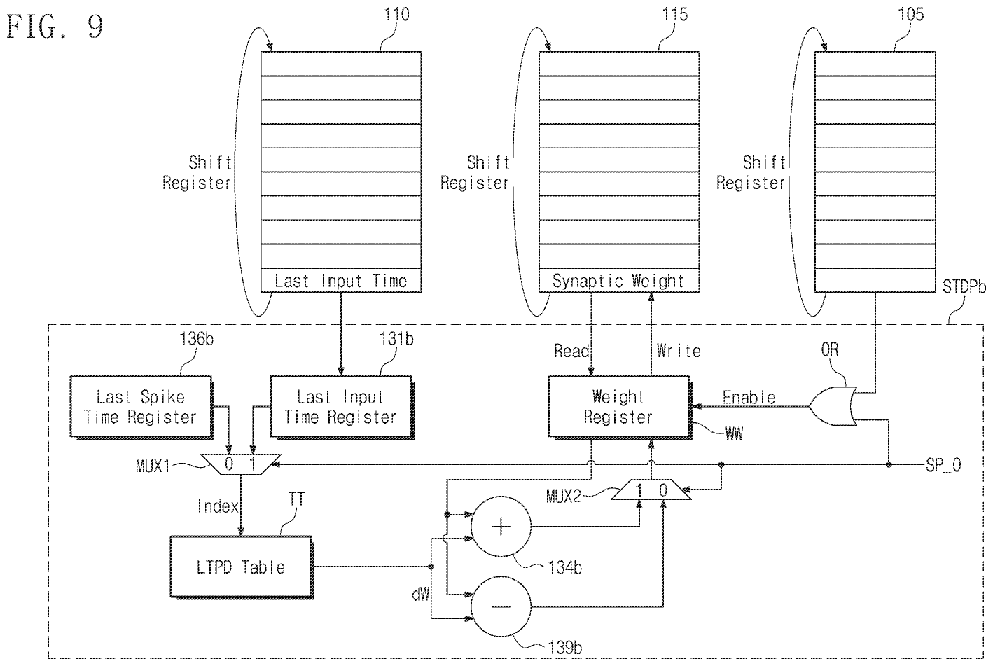

FIGS. 8 and 9 are diagrams illustrating that an LTP learning circuit and an LTD learning circuit are integrated. FIG. 8 is a diagram illustrating an STDP learning circuit STDPa in which the LTP 130 of FIG. 6B and the LTD 135 of FIG. 7B are integrated. FIG. 9 is a diagram illustrating an STDP learning circuit STDPb in which the LTP table 132 and the LTD table 137 are integrated in FIG. 8. The STDP learning circuit STDPa and the STDP learning circuit STDPb may be examples of the online learning circuit 15 according to FIG. 3.

Referring to FIGS. 6B, 7B, and 8, the STDP learning circuit STDPa may include a last input time register 131a, an LTP table 132a, an adder 134a, a last spike time register 136a, an LTD table 137a, a subtractor 139a, a weight register WW, a MUX circuit MUX, and an OR gate OR. The last input time register 131a, the LTP table 132a, and the adder 134a are similar to the last input time register 131, the LTP table 132, and the adder 134 of FIG. 6B, and thus detailed descriptions thereof will be omitted to avoid redundancy. The last spike time register 136a, the LTD table 137a, and the subtractor 139a are similar to the last spike time register 136, the LTD table 137, and the subtractor 139 of FIG. 7B, and thus detailed descriptions thereof will be omitted to avoid redundancy.

The weight register WW may be similar to the weight register 133 of FIG. 6B or the weight register 138 of FIG. 7B. The weight register WW may read out the current synaptic weight W1 from the synaptic weight register 115 or may upload the updated synaptic weight W2.

The weight register WW may provide the current synaptic weight W1 to the adder 134a and the subtractor 139a. The adder 134a may add the first weight learning rate value dW1 provided from the LTP table 132a to the synaptic weight W1. The added value may be provided to the MUX circuit MUX. The subtractor 139a may subtract the second weight learning rate value dW2 provided from the LTD table 137a from the synaptic weight W1. The subtracted value may be provided to the MUX circuit MUX.

The MUX circuit MUX may select one of the added value or the subtracted value depending on the spike output signal SP_O and then may provide the selected one to the weight register WW. For example, when the spike output signal SP_O is 1, the MUX circuit MUX may output the added value. When the spike output signal SP_O is 0, the MUX circuit MUX may output the subtracted value. The output value of the MUX circuit MUX may be referred to as the “updated synaptic weight W2”.

According to an embodiment, the weight register WW may operate based on the activation signal “enable”. The activation signal “enable” may be generated through the OR gate OR. The OR gate OR may perform an OR operation on the spike output signal SP_O and the input activation signal “Input Enable” of the input register 105.

Referring to FIGS. 8 and 9, the STDP learning circuit STDPb may include a last input time register 131b, an adder 134b, a last spike time register 136b, a subtractor 139b, an LTPD table TT, the weight register WW, a first MUX MUX1, a second MUX MUX2, and the OR gate OR. The last input time register 131b, the adder 134b, the last spike time register 136b, the subtractor 139b, the weight register WW, the second MUX MUX2, and the OR gate OR of FIG. 9 are similar to the last input time register 131a, the adder 134a, the last spike time register 136a, the subtractor 139a, the weight register WW, the MUX circuit MUX, and the OR gate OR of FIG. 8, and thus a detailed description thereof will be omitted to avoid redundancy.

The LTPD table TT may be a table in which the LTP table 132a and the LTD table 137a of FIG. 8 are integrated. Because the LTP table 132a and the LTD table 137a are memories for storing quantized real numbers, the LTP table 132a and the LTD table 137a may occupy a large area. Accordingly, when the two tables are integrated, a circuit area may be reduced.

The first MUX MUX1 may receive the last input time from the last input time register 131b and may receive the last spike time from the last spike time register 136b. The first MUX MUX1 may output the last input time or the last spike time to the LTPD table TT based on the spike output signal SP_O. For example, when the spike output signal SP_O is 1, the first MUX MUX1 may output the last input time to the LTPD table TT. For example, when the spike output signal SP_O is 0, the first MUX MUX1 may output the last spike time to the LTPD table TT.

FIG. 10 is a diagram illustrating a hidden layer, to which a neuron circuit is applied, according to an embodiment of the present disclosure. Referring to FIG. 10, a hidden layer 1000 may include first to fourth neuron circuits 1100, 1200, 1300, and 1400 and first to third OR gates 1150, 1250, and 1350. According to an embodiment, the hidden layer 1000 may include more or fewer neuron circuits and OR gates. That is, the number of neuron circuits and the number of OR gates are not limited to the embodiment of FIG. 10.

Each of the first to fourth neuron circuits 1100, 1200, 1300, and 1400 may be the neuron circuit 10 or 100 of FIG. 3 or 4. Each of the first to fourth neuron circuits 1100, 1200, 1300, and 1400 may receive the spike input signal SP_I from neurons before a synapse and then may generate first to fourth spike output signals SP_O1, SP_O2, SP_O3, and SP_O4 through synaptic weights.

The third OR gate 1350 may perform an OR operation on the third spike output signal SP_O3 and the fourth spike output signal SP_O4. An output signal of the third OR gate 1350 may be provided to the second OR gate 1250. The second OR gate 1250 may perform an OR operation on the second spike output signal SP_O2 and the output signal of the third OR gate 1350. An output signal of the second OR gate 1250 may be provided to the first OR gate 1150. The first OR gate 1150 may perform an OR operation on the first spike output signal SP_O1 and the output signal of the second OR gate 1250. The output signal of the second OR gate 1250 may be referred to as a “lateral suppression signal SIG_LI”.

According to an embodiment, the lateral suppression signal SIG_LI may be provided to the first to fourth neuron circuits 1100, 1200, 1300, and 1400, and may be used to reset the membrane potential value to zero. For example, in FIG. 4, when the lateral suppression signal SIG_LI is 1 and the spike output signal SP_O is 0, (i.e., when the corresponding neuron circuit does not generate a spike and another neuron circuit in a layer generates a spike), the AND gate 170 may output 1. As a result, this signal causes the membrane potential register 165 to reset the membrane potential value to 0, thereby suppressing the spike generation of the corresponding neuron circuit. Accordingly, while the hidden layer 1000 performs an online learning operation through the first to fourth neuron circuits 1100, 1200, 1300, and 1400, a circuit area may be reduced through an OR gate chain configuration.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

According to an embodiment of the present disclosure, because a neuron circuit includes an online learning circuit, the neuron circuit may quickly perform learning with less hardware and may increase the accuracy of the learning. Furthermore, because the neuron circuit is implemented in hardware, the execution time and power consumption may be reduced.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A neuron circuit comprising:
a first internal circuit configured to receive a plurality of spike input signals, to generate a first sum value by summing a plurality of synaptic weights corresponding to the plurality of spike input signals, and to output a second sum value by adding a membrane potential value to the first sum value;
a spike generating circuit configured to generate a spike output signal by comparing the second sum value with a threshold potential value;
a membrane potential generating circuit configured to generate the membrane potential value, which is obtained by subtracting the threshold potential value from the second sum value, based on the spike output signal and a lateral suppression signal;
a second internal circuit configured to count a last spike time based on the spike output signal; and
an online learning circuit configured to:
receive a last input time from the first internal circuit and perform long-term potentiation (LTP) learning based on the last input time; or
receive the last spike time from the second internal circuit and to perform long-term depression (LTD) learning based on the last spike time.

2. The neuron circuit of claim 1, wherein the first internal circuit includes:
an input register configured to convert and store the plurality of spike input signals into a Boolean value;
a first count register configured to count the last input time, which is a time difference between a time, at which each of the plurality of spike input signals is input, and a time at which the spike output signal is generated;
a synaptic weight register configured to generate the first sum value by sequentially extracting and summing synaptic weight values, the Boolean value of each of which is “True”; and
a first adder configured to generate the second sum value by adding the membrane potential to the first sum value.

3. The neuron circuit of claim 2, wherein the first count register is further configured to:
when the spike output signal is ‘1’, reset the last input time.

4. The neuron circuit of claim 1, wherein the spike generating circuit includes:
a comparator configured to compare the second sum value with the threshold potential value, and to generate a spike generation signal when the second sum value is greater than the threshold potential value;
a spike generator configured to generate the spike output signal in response to the spike generation signal; and
a Vth regulator configured to provide the comparator with the threshold potential value by adjusting the threshold potential value based on the spike output signal.

5. The neuron circuit of claim 4, wherein the Vth regulator is further configured to output the threshold potential value by adding a threshold potential regulation value to an existing threshold potential value thus stored, when the spike output signal is ‘1’.

6. The neuron circuit of claim 1, wherein the membrane potential generating circuit includes:
a first MUX configured to output a leakage value or the threshold potential value based on the spike output signal;
a first subtractor configured to subtract an output value of the first MUX from the second sum value;
a second MUX configured to output an output value of the first subtractor or ‘0’ based on a selection signal; and
a membrane potential register configured to store an output value of the second MUX as the membrane potential value.

7. The neuron circuit of claim 6, wherein the first MUX is further configured to:
output the threshold potential value when the spike output signal is ‘1’; and
output the leakage value, which is a constant value obtained by modeling a leakage current with time, when the spike output signal is ‘0’.

8. The neuron circuit of claim 6, wherein the second MUX is further configured to:
output ‘0’ based on the selection signal of ‘1’ when each of an inverted signal of the spike output signal and the lateral suppression signal is ‘1’; and
output an output value of the first subtractor based on the selection signal of ‘0’ when at least one of the inverted signal and the lateral suppression signal is not ‘1’.

9. The neuron circuit of claim 1, wherein the second internal circuit includes:
a second count register configured to count the last spike time, which is a time elapsed after a spike has finally generated, and
wherein the second count register is further configured to:
reset the last spike time when the spike output signal is ‘1’.

10. The neuron circuit of claim 1, wherein the online learning circuit includes:
an LTP learning circuit configured to update the plurality of synaptic weights based on the last input time; and
an LTD learning circuit configured to update the plurality of synaptic weights based on the last spike time.

11. The neuron circuit of claim 10, wherein the LTP learning circuit includes:
a last input time register configured to load and store the last input time from the first internal circuit;
an LTD table configured to store a second weight learning rate value, which is quantized by setting the last spike time to an index;
a first weight register configured to load a current synaptic weight from the first internal circuit and to upload a first update synaptic weight to the first internal circuit; and
a second adder configured to generate the first update synaptic weight by adding the first weight learning rate value to the current synaptic weight.

12. The neuron circuit of claim 11, wherein the LTD learning circuit includes:
a last spike time register configured to load and store the last spike time from the second internal circuit;
an LTD table configured to store a second weight learning rate value, which is quantized by setting the last spike time to an index;
a second weight register configured to load the current synaptic weight from the first internal circuit and to upload a second update synaptic weight to the first internal circuit; and
a second subtractor configured to generate the second update synaptic weight by subtracting the second weight learning rate value from the current synaptic weight.

13. The neuron circuit of claim 12, wherein the second weight register is further configured to:
load the current synaptic weight or upload the second update synaptic weight, in response to an activation signal.

14. The neuron circuit of claim 12, wherein the first weight register and the second weight register consist of a single integrated weight register, and
wherein the online learning circuit further includes:
a MUX circuit configured to:
output the first update synaptic weight to the integrated weight register when the spike output signal is ‘1’; and
output the second update synaptic weight to the integrated weight register when the spike output signal is ‘0’.

15. A spiking neural network circuit including one hidden layer, the one hidden layer comprising:
a plurality of neuron circuits, each of which performs online learning based on a spike timing dependent plasticity (STDP) algorithm; and
an OR gate configured to perform an OR operation on a first spike output signal, which is an output of a first neuron circuit, and a second spike output signal, which is an output of a second neuron circuit, with respect to the first neuron circuit and the second neuron circuit, which are adjacent to each other, among the plurality of neuron circuits.

16. The spiking neural network circuit of claim 15, wherein the OR gate configured to generate a lateral suppression signal based on the first spike output signal and the second spike output signal.

17. The spiking neural network circuit of claim 16, wherein each of the plurality of neuron circuits includes:
a first internal circuit configured to receive a plurality of spike input signals, to generate a first sum value by summing a plurality of synaptic weights corresponding to the plurality of spike input signals, and to output a second sum value by adding a membrane potential value to the first sum value;
a spike generating circuit configured to generate a spike output signal by comparing the second sum value with a threshold potential value;
a membrane potential generating circuit configured to generate the membrane potential value, which is obtained by subtracting the threshold potential value from the second sum value, based on the spike output signal and the lateral suppression signal;
a second internal circuit configured to count a last spike time based on the spike output signal; and
an online learning circuit configured to:
receive a last input time from the first internal circuit and perform LTP learning based on the last input time; or
receive the last spike time from the second internal circuit and to perform LTD learning based on the last spike time.
